(19) United States
(12) Patent Application Publication
(10) Pub. No.: US 2020/0333005 A1
(43) Pub. Date: Oct. 22, 2020

(54) NON-METALLIC IGNITION DEVICES

(71) Applicant: Purdue Research Foundation, West Lafayette, IN (US)

(72) Inventors: Jeffrey Frederick Rhoads, West Lafayette, IN (US); Bryan W. Boudouris, West Lafayette, IN (US); Steven Forrest Son, West Lafayette, IN (US); Miranda P McConnell, West Lafayette, IN (US)

(73) Assignee: Purdue Research Foundation, West Lafayette, IN (US)

(21) Appl. No.: 16/509,673

(22) Filed: Jul. 12, 2019

Related U.S. Application Data
(60) Provisional application No. 62/720,947, filed on Aug. 22, 2018.

(51) Int. Cl. F23Q 3/00; F42B 3/195; B60R 21/26; B41M 3/00

(52) U.S. Cl. CPC F23Q 3/006; F42B 3/195; B60R 2021/26029; B41M 3/006; B60R 21/26

(57) ABSTRACT

The present disclosure relates to novel non-metallic ignition devices, and the method of making and using the novel non-metallic ignition devices.

### CROSS-REFERENCE TO RELATED APPLICATION

This application claims the benefits of U.S. Provisional Application Ser. No. 62/720,947 filed Aug. 22, 2018, the contents of which are incorporated herein entirely.

### GOVERNMENT RIGHTS

This invention was made with government support under U.S. Department of Defense Grant No. HDTRA1-15-1-0010. The United States government has certain rights in the invention.

### TECHNICAL FIELD

The present disclosure relates to a novel non-metallic ignition devices, and the method of making and using the novel non-metallic ignition devices.

### BACKGROUND

This section introduces aspects that may help facilitate a better understanding of the disclosure. Accordingly, these statements are to be read in this light and are not to be understood as admissions about what is or is not prior art.

Igniters are an integral component of many devices, including automobile passenger restraint systems (airbags), seat belt tensioning devices, blasting charges for mining or construction, and the like. To the best knowledge of the present disclosure, all currently available commercial igniters are made with metallic components. Although metallic igniters have some advantages such as low resistance, they also have a number of drawbacks including susceptibility to corrosion, high density, and safety issue when it is used in automobile passenger restraint systems (airbags).

Conductive polymer was found to be used in certain kind of igniters as a bridging conductive materials. See U.S. Pat. No. 7,834,295 B2. However, the igniters disclosed there still used metallic electrodes. When a metal-containing igniter equipped in an automobile airbag is activated, metal pieces released may cause serious damages to passengers in the automobile.

Therefore, there is still a need to develop metal-free igniters that can provide both comparable igniting functions as provided by traditional metal-containing igniters and provide safer solutions especially for consumer products such as automobile passenger restraint systems (airbags).

### SUMMARY

The present disclosure relates to novel non-metallic ignition devices, and the method of making and using the novel non-metallic ignition devices.

In one embodiment, the present disclosure provides a non-metallic ignition device comprising:
a) two non-metallic electrodes in a spaced-apart configuration, wherein the two non-metallic electrodes are made by a material comprising a conductive polymer;
b) an electric voltage source that applies an electric voltage to the two non-metallic electrodes, wherein the electric voltage source is capable of generating an electric arc between the two non-metallic electrodes; and
c) a gap between the two non-metallic electrodes;
wherein there is no electric conductive device connecting the two non-metallic electrodes.

In one embodiment, the present disclosure provides a method of making a non-metallic ignition device, wherein the method comprises:
a) providing a composition comprising a conductive polymer;
b) providing a mold to prepare conductive polymer electrodes with suitable dimensions;
c) attaching said conductive polymer electrodes to a substrate to ensure that there is a suitable gap between each set of two conductive polymer electrodes.

### BRIEF DESCRIPTION OF THE DRAWINGS

FIG. 1 shows a doctor blade printed PANI spark gap igniter on a flexible substrate.

FIG. 2 shows the recorded breakdown voltage for PANI spark gaps compared to measured gap width.

FIG. 3 shows (3a) high speed footage of ignited nanothermite printed on a PANI spark gap igniter and (3b) pre- and post-ignition sample of nanothermite printed on a PANI spark gap igniter.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure the term “about” can allow for a degree of variability in a value or range, for example, within 10%, within 5%, or within 1% of a stated value or of a stated limit of a range.

In the present disclosure the term “substantially” can allow for a degree of variability in a value or range, for example, within 90%, within 95%, or within 99% of a stated value or of a stated limit of a range.

In the present disclosure the term “conductive polymer” may refer to any organic polymer that is capable of conducting electricity. Non limiting examples of conductive polymer may be polyaniline (PANI), polyacetylene, polypyrrole, polyfuran, polythiophene, polyacetylene, poly(p-phenylenevinylene), poly(3,4-ethylenedioxythiophene) doped with poly(styrene sulfonate) (PEDOT:PSS), or any combination thereof. In one aspect, the conductive polymer comprises polyaniline (PANI).

In the present disclosure the term “nanothermite” or “energetic material” may be any material that can release chemical energy stored in their molecular structure. Upon external stimulations, such as heat, shock, electric current, or electric arc, these materials are capable of emitting energy in a very short time. An energetic material may be but is not limited to 1,3,5-trinitroperhydro-1,3,5-triazine (RDX), octahydro-1,3,5,7-tetranitro-1,3,5,7-tetrazocine (HMX), 2,4,6-trinitrotoluene (TNT), pentaerythritol tetranitrate (PETN), nitroglycerine (NG), nitrocellulose (NC), 3,3′-diamino-4,4′-azoxyfurazan (DAAF), 3,6-bis(1H-1,2,3,4-tetrazol-5-yl-amino)-1,2,4,5-tetrazine (BTATZ), hexanitrohexaazaisowurtzitane (CL-20), 1,3,5-triamino 2,4,6-trinitrobenzene (TATB), ammonium perchlorate (AP), or any combination thereof. An energetic material can also include at least one oxidizing agent and at least one metal reducing agent. The oxidizing agent may be oxygen, an oxygen-based gas, a solid oxidizing agent, or a combination thereof. In one embodiment, the oxidizing agent may be a metal-containing oxidizing agent, which may comprise a perchlorate, chlorate, metal oxide, or an organic binder.

In a particular embodiment, the metal-containing oxidizing agent is a perchlorate or chlorate of an alkali metal or an alkaline earth metal selected from the group consisting of potassium perchlorate (KClO₄), potassium chlorate (KClO₃), lithium perchlorate (LiClO₄), sodium perchlorate (NaClO₄), magnesium perchlorate (Mg(ClO₄)₂), and combinations thereof. In another embodiment, the metal-containing oxidizing agent is a metal oxide selected from the group consisting of MoO₃, Fe₂O₃, Fe₃O₄, V₂O₅, CrO₃, Cr₂O₃, MnO₂, CO₃O₄, Ag₂O, CuO, WO₃, MgO, Nb₂O₅, MgAl₂O₄, Ce₂O₃, Bi₂O₃, and combinations thereof. A metal reducing agent may be selected from the group consisting of molybdenum, magnesium, calcium, strontium, barium, boron, titanium, zirconium, vanadium, niobium, tantalum, chrom um, tungsten, manganese, iron, cobalt, nickel, copper, zinc, cadmium, tin, antimony, bismuth, aluminum, silicon, and combinations thereof. Preferably, the metal reducing agent is aluminum, zirconium, titanium, or a combination thereof.

In one embodiment, the present disclosure provides a non-metallic ignition device comprising:
a) two non-metallic electrodes in a spaced-apart configuration, wherein the two non-metallic electrodes are made by a material comprising a conductive polymer;
b) an electric voltage source that applies an electric voltage to the two non-metallic electrodes, wherein the electric voltage source is capable of generating an electric arc between the two non-metallic electrodes; and
c) a gap between the two non-metallic electrodes;
wherein there is no electric conductive device connecting the two non-metallic electrodes.

In one embodiment, the present disclosure provides a non-metallic ignition device, wherein the device further comprises an energetic material that is capable of being ignited by an electric arc.

In one embodiment, the present disclosure provides a non-metallic ignition device, wherein the energetic material is positioned at the gap between the two non-metallic electrodes.

In one embodiment, the present disclosure provides a non-metallic ignition device, wherein the conductive polymer comprises polyaniline, polyacetylene, polypyrrole, polyfuran, polythiophene, polyacetylene, poly(p-phenylenevinylene), poly(3,4-ethylenedioxythiophene) doped with poly(styrene sulfonate) (PEDOT:PSS), or any combination thereof. In one aspect, the conductive polymer comprises polyaniline.

In one embodiment, the present disclosure provides a non-metallic ignition device, wherein the non-metallic electrodes are attached to a flexible substrate. In one aspect, the flexible substrate may be any plastic like material such as but is not limited to polyethylene (PE), polypropylene (PP), polylactic acid, or even paper sheet. In one aspect, the flexible substrate may be any flexible polyester. In one aspect, the flexible substrate may be any flexible polyester such as but is not limited to polyhydroxyalkanoates such as poly-3-hydroxybutyrate, polyhydroxyvalerate, polyhydroxyhexanoate; polylactic acid polyesters; polybutylene succinate, polycaprolactone, starch and starch derivatives, cellulose esters such as cellulose acetate and nitrocellulose and derivatives thereof (such as celluloid), or polyethylene terephthalate (PET).

In one embodiment, the present disclosure provides a non-metallic ignition device comprising an energetic material, wherein the energetic material may be positioned at the gap between the two non-metallic electrodes, or mixed/integrated with a conductive polymer to become part of the non-metallic electrodes.

In one embodiment, the present disclosure provides a non-metallic ignition device comprising two non-metallic electrodes, wherein the non-metallic electrodes have a thickness of about 0.5-500 μm, 0.5-250 μm, 0.5-100 μm, 0.5-75 μm, 0.5-50 μm, 0.5-25 μm, 0.5-10 μm, 5-500 μm, 5-250 μm, 5-100 μm, 5-75 μm, 5-50 μm, 5-25 μm, or 5-10 μm.

In one embodiment, the present disclosure provides a non-metallic ignition device comprising two non-metallic electrodes spaced-apart with a gap, wherein the width of the gap is about 0.1-20 mm, 0.1-10 mm, 0.1-5 mm, 0.1-2.5 mm, 1-20 mm, 1-10 mm, 1-5 mm, or 1-2.5 mm.

In one embodiment, the present disclosure provides a non-metallic ignition device with an electric voltage source, wherein the electric voltage source applies a high electric voltage between 0.1-50 kV, 0.1-25 kV, 0.1-10 kV, 1-50 kV, 1-25 kV, or 1-10 kV; and wherein the electric voltage source applies a low current between 0.1-200 μA, 0.1-100 μA, 0.1-50 μA, 1-200 μA, 1-100 μA, or 1-50 μA.

In one embodiment, the present disclosure provides a method of making non-metallic ignition device of the present disclosure, wherein the method comprises:
a) providing a composition comprising a conductive polymer;
b) providing a mold to prepare conductive polymer electrodes with suitable dimensions; and
c) attaching said conductive polymer electrodes to a substrate to ensure that there is a suitable gap between each set of two conductive polymer electrodes.

In one embodiment, the present disclosure provides a method of making non-metallic ignition device of the present disclosure, wherein the non-metallic ignition device is prepared by printing said conductive polymer electrodes to said substrate. In one aspect, the printing is achieved by a doctor blade printing method.

Since the 1930s, metallic igniters have been used in applications ranging from pulsed power thrusters to explosive initiators. Metallic igniters have low resistance, but have a number of drawbacks including susceptibility to corrosion and high density. A conductive polymer igniter would provide a metal-free alternative to these traditional initiation systems. Conductive polymers have shown promising conductivity, flexibility, and use in light-weight applications due to their low densities. These materials have the added feature of corrosion resistance, as well as easily tailorable chemical properties, allowing for their use in a variety of applications including sensors and nano-scale devices such as LEDs. Furthermore, conductive polymers lend themselves well to various additive manufacturing techniques.

Conductive polymers such as polyaniline (PANI) have proven to be a useful base in electronics applications. PANI solutions have demonstrated conductivity on the order of 100 S/cm and useful properties such as corrosion resistance and flexibility and thus could form the foundation of a viable substitute for more traditional ignition systems. These solutions have been thermally inkjet printed to create thin conductive films with high resolution and have been successfully used in applications such as ammonia gas sensors. Polyaniline's most conductive state is in its emeraldine salt form when it is doped with a protonic acid, such as camphorsulfonic acid (CSA). When combined with a secondary dopant and/or solvent, such as m-cresol, polyaniline films have demonstrated properties similar to metal films at high temperatures.

The present disclosure investigated the effectiveness of a spark gap igniter made with conductive polymer such as a PANI solution, which involves a high voltage, low current discharge across two leads separated by a gap. These ignition systems have been successfully triggered on the sub-microsecond scale, which is critical in events such as a vehicle accident or explosive ignition. In addition, the low current required to create a voltage breakdown across a spark gap allows for the use of small capacitors for ignition, minimizing the total space needed for the entire ignition system. This disclosure therefore demonstrated the feasibility using a conductive polymer such as PANI as a substitute for traditional metals in fabrication of spark gaps igniters using doctor blading.

Ink Formulation

To create a solution viable for doctor blading, polyaniline powder (3M) was doped with camphorsulfonic acid (99%, Sigma Aldrich) by crushing the two constituents into a fine powder with a mortar and pestle at a ratio of 10 to 6 repeat units of aniline to each camphorsulfonic acid molecule. m-Cresol was chosen as the solvent for this ink because of its low viscosity and ability to increase the conductivity of the solution through secondary doping . m-Cresol (99%, Fisher Scientific) was added to the conductive powder, and the solution was mixed in a resonant mixer (LabRAM, Resodyn Acoustic Mixers, Inc.) at 80% intensity for 8 minutes, overturned, then mixed at 80% intensity for an additional 8 minutes. An 8 wt % solids loading was found through testing to be the highest solids loading to ensure homogeneous sample fabrication with the doctor blading technique.

Sample Fabrication

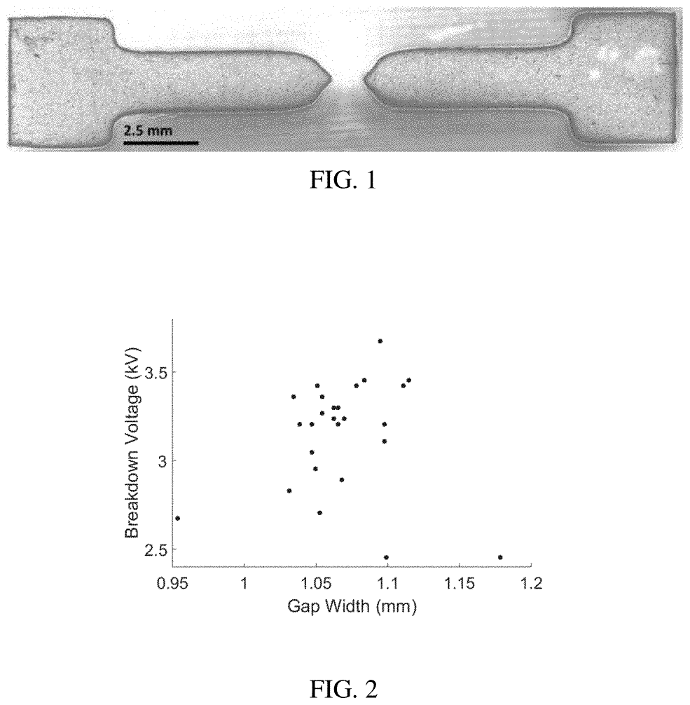

Spark gap igniter samples were fabricated using a doctor blade printing technique. Negative molds of spark gap geometries were cut from cling vinyl (Cricut Explore One) and adhered to an inkjet printing transparency substrate (Mitsubishi Imaging, Inc.) that provided improved geometric control for polar solvents. The 8 wt % solids solution was sonicated (1800 Ultrasonic Cleaner, Branson Ultrasonics) for one hour prior to use, then pipetted on the edge of the molds. A plastic card was used as a squeegee to evenly distribute the solution into the molds. The cling vinyl was left on the substrate overnight to maximize print geometry control during solvent evaporation. Subsequently the cling vinyl was removed, and the samples were cured in an oven (APT.line ED, Binder, Inc.) at 85° C. for one hour to remove the remaining solvent. The resulting prints were conductive polymer spark gap igniters printed on a flexible substrate, shown in FIG. 1. A group of 10 of the spark gap substrates were massed before and after sample deposition, revealing an average of 6.19 mg of conductive ink per sample.

To demonstrate the ability of the spark gap igniters to ignite material, Al—Bi₂O₃ nanothermite was deposited on top of eight additional spark gaps using a BioFluidix PipeJet P9 system with a 500 μm nozzle. Nano-aluminum (82% active aluminum, NovaCentrix, 80 nm) and nano-bismuth oxide (Nanophase Technologies Corporation, 38 nm) were mixed in a solution of Solsperse (Lubrizol) and dimethylformamide (DMF, Sigma Aldrich) in a resonant mixer (LabRAM, Resodyn Acoustic Mixers, Inc.). The ink was mixed at an 80% intensity for 8 minutes, overturned, then mixed at 80% intensity for an additional 8 minutes. The solution was re-suspended for 30 minutes before printing using a sonicating bath (1800 Ultrasonic Cleaner, Branson Ultrasonics), then deposited on the selected eight spark gaps.

Test Setup

The spark gap igniters were tested with a high voltage power supply (Stanford Research Systems, PS365) with a voltage maximum set at 5.2 kV and current maximum set at 50 μA. The samples were fastened to a plastic plate using flat alligator clips to prevent the sample from bending during testing. An oscilloscope (Agilent, DSO6014A) was connected to the power supply to record the voltage at the spark over event.

Results

Breakdown voltages for the spark gap igniters without nanothermite present are shown in FIG. 2. Of the 26 samples tested, all successfully sparked over, with a mean of 3.14 kV and standard deviation of 0.31 kV. The spark gap samples displayed no visible signs of degradation after sparking over. A single spark gap igniter was fired multiple times to test the robustness of the igniter, and fired successfully each time. Gap width was calculated from the approximate distance measured in pixels from one lead of the spark gap to the other to provide a more accurate small scale measurement. The distance in pixels was then converted to mm based on a calibration slide provided with the camera.

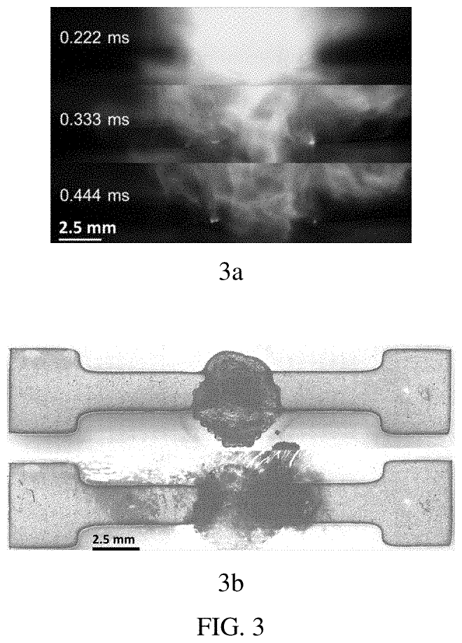

The spark gap igniters with nanothermite present were tested in the same manner as those without nanothermite. All eight of the spark gaps successfully ignited the deposited nanothermite material with the reaction captured by a high speed camera (Phantom V10) with a frame rate of 9000 fps and 60 μs exposure. Still frames from a representative event are shown in FIG. 3a. This sample ignited at a breakdown voltage of 4.41 kV, slightly higher than the breakdown voltage required for a spark gap without nanothermite due to the added resistance of the nanothermite between the leads. Before and after images of the nanothermite on the PANI spark gap are shown in FIG. 3b.

The present disclosure demonstrated that PANI conductive polymer ink can be made into functional spark gap igniters using doctor blading. All of the spark gap igniters successfully sparked over and showed no visible sign of degradation after sparking over in single-use testing. With the doctor blade technique demonstrated here, the geometry of PANI spark gaps igniters can be tailored to fit existing circuits or initiation systems; the negative mold cutting technique allows for the freedom in changing the gap width, creating the ability to tailor the spark gap size to fit the system in which it is used. Doctor blading has proven a successful avenue for producing polyaniline igniters and can now be exploited on a larger manufacturing scale for applications such as air bags.

The spark gap igniters presented in the present disclosure have opened the door for their development into a complete novel ignition system, and have the possibility of being integrated directly with energetic materials. The creation of a completely metal-free ignition system opens many doors for applications needing corrosion resistant and lightweight igniters. These results have paved the way for future integration of energetic materials with conductive polymer spark gap igniters.

Those skilled in the art will recognize that numerous modifications can be made to the specific implementations described above. The implementations should not be limited to the particular limitations described. Other implementations may be possible.

We claim:

1. A non-metallic ignition device comprising:
a) two non-metallic electrodes in a spaced-apart configuration, wherein the two non-metallic electrodes are made by a material comprising a conductive polymer;
b) an electric voltage source that applies an electric voltage to the two non-metallic electrodes, wherein the electric voltage source is capable of generating an electric arc between the two non-metallic electrodes; and
c) a gap between the two non-metallic electrodes;
wherein there is no electric conductive device connecting the two non-metallic electrodes.

2. The non-metallic ignition device of claim 1, wherein the device further comprises an energetic material that is capable of being ignited by the electric arc.

3. The non-metallic ignition device of claim 1, wherein the energetic material is selected from the group consisting of 1,3,5-trinitroperhydro-1,3,5 -triazine (RDX), octahydro-1,3,5,7-tetranitro-1,3,5,7-tetrazocine (HMX), 2,4,6-trinitrotoluene (TNT), pentaerythritol tetranitrate (PETN), nitroglycerine (NG), nitrocellulose (NC), 3,3′-diamino -4,4′-azoxyfurazan (DAAF), 3,6-bis(1H-1,2,3,4-tetrazol-5-yl-amino)-1,2,4,5-tetrazine (BTATZ), hexanitrohexaazaisowurtzitane (CL-20), 1,3,5-triamino 2,4,6-trinitrobenzene (TATB), ammonium perchlorate (AP), and any combination thereof.

4. The non-metallic ignition device of claim 1, wherein the energetic material comprises at least one oxidizing agent and at least one metal reducing agent, wherein the oxidizing agent is MoO₃, Fe₂O₃, Fe₃O₄, V₂O₅, CrO₃, Cr₂O₃, MnO₂, CO₃O₄, Ag₂O, CuO, WO₃, MgO, Nb₂O₅, MgAl₂O₄, Ce₂O₃, Bi₂O₃, or combinations thereof, wherein the metal reducing agent is molybdenum, magnesium, calcium, strontium, barium, boron, titanium, zirconium, vanadium, niobium, tantalum, chromium, tungsten, manganese, iron, cobalt, nickel, copper, zinc, cadmium, tin, antimony, bismuth, aluminum, silicon, or any combinations thereof.

5. The non-metallic ignition device of claim 1, wherein the energetic material is positioned at the gap between the two non-metallic electrodes or mixed with the conductive polymer to become part of the non-metallic electrodes.

6. The non-metallic ignition device of claim 1, wherein the conductive polymer comprises polyaniline, polyacetylene, polypyrrole, polyfuran, polythiophene, polyacetylene, poly(p-phenylenevinylene), poly(3,4-ethylenedioxythiophene) doped with poly(styrene sulfonate) (PEDOT:PSS), or any combination thereof.

7. The non-metallic ignition device of claim 1, wherein the conductive polymer is polyaniline.

8. The non-metallic ignition device of claim 1, wherein the two non-metallic electrodes are attached to a flexible substrate.

9. The non-metallic ignition device of claim 1, wherein the two non-metallic electrodes are made by a material comprising a substantially homogenous mixture of a conductive polymer and an energetic material.

10. The non-metallic ignition device of claim 1, wherein the width of the gap is 1-5 mm.

11. The non-metallic ignition device of claim 1, wherein the non-metallic electrodes have a thickness of 5-100 μm.

12. The non-metallic ignition device of claim 1, wherein the electric voltage source applies a high electric voltage between 1-10 kV and a low current between 1-200 μA.

13. A method of making non-metallic ignition device of claim 1, wherein the method comprises:
a) providing a composition comprising a conductive polymer;
b) providing a mold to prepare conductive polymer electrodes with suitable dimensions; and
c) attaching said conductive polymer electrodes to a substrate to ensure that there is a suitable gap between each set of two conductive polymer electrodes.

14. The method of claim 13, wherein the non-metallic ignition device of claim 1 is prepared by printing said conductive polymer electrodes to said substrate.

15. The method of claim 14, wherein the printing is achieved by a doctor blade printing method.
